(19) United States
(12) Patent Application Publication
(10) Pub. No.: US 2010/0148564 A1
(43) Pub. Date: Jun. 17, 2010

(54) Save device

(76) Inventor: Theresa B. Lewis Carter, Montgomery, AL (US)

Correspondence Address: Theresa B Lewis, 1501 Rhodes St., Montgomery, AL, 36106, US

(21) Appl. No.: 12/286,607

(22) Filed: Nov. 18, 2008

Related U.S. Application Data
(60) Provisional application No. 61/003,540, filed on Nov. 19, 2007.

(51) Int. Cl. B60R 21/00

(52) U.S. Cl. 297/465

(57) ABSTRACT

The present invention is a Safety Air Vest Equipment device (S.A.V.E.). The vest includes a shell with a neck and torso opening, and a pair of opposed arm holes. The vest also has an air hose attached, with a one-way valve and quick release valve. The air vest is configured to expand on the wearers neck and upper torso area thus preventing the wearer from sustaining severe cervical and spinal cord injuries. The device would also allow the user to avoid the impact from the force of the air bag being deployed.

The device includes buckles in the front of the vest, a seat buckle belt in the rear of the vest, which is attached to the seat. It also has a pivoting hinge which allows forward and backward movement, and prevents the wearer from being ejected from the vehicle. It also has an air hose with a quick release valve and a one-way valve to enables the vest to be disconnected quickly, while remaining inflated until the wearer arrives at a medical facility. While the invention has been described in detail, it will be better understood by those skilled in the art, that changes may be made in the air vests material and equivalents may be substituted without departing from the true spirit and scope of the invention.

This application claims priority to U.S. Provisional Application 61/003,540, filed Nov. 19, 2007.

### BACKGROUND OF THE INVENTION

1. Field of Invention

The present invention relates to an inflatable survival air vest, and particularly to a vest that inflates with the vehicles air bag. The vest would provide a protective safety measure for wearers during a vehicle accident.

2. Description of Related Material

One of the most serious dangers faced by individuals in vehicle crashes is the whipping effect that is placed on the head, neck and spinal cord. This occurs when the vehicle moving forward is abruptly hit and vehicle speed is decreased immediately causing the occupants of the vehicle to be suddenly thrown forward and back. The deadly effects of whiplash is well known by medical personnel in that cervical and or spinal cord injuries can be life-threatening; thus making the need for the Safety Air Vest Equipment (S.A.V.E.) device abundantly clear. Vehicle air bags have been developed to address the issue of occupants safety during an accident. Seat belts are also helpful to keep the occupants securely in their seats, but the occupants head will still jerk back and fourth. By using the Safety Air Vest Equipment (S.A.V.E.) device air is pushed through the vest allowing the occupants head, neck and spinal cord to be stabilized; thus reducing the chances of whiplash and spinal cord injuries.

### SUMMARY OF THE INVENTION

The present invention is a Safety Air Vest Equipment device (S.A.V.E.). The vest includes a shell with a neck and torso opening, and a pair of opposed arm holes. The vest also has an air hose attached, with a one-way valve and quick release valve. The air vest is configured to expand on the wearers neck and upper torso area thus preventing the wearer from sustaining severe cervical and spinal cord injuries. The device would also allow the user to avoid the hit from the force of the air bag being deployed.

The device includes buckles in the front of the vest, a seat buckle belt in the rear of the vest, which is attached to the seat. It also has a pivoting hinge which allows forward and backward movement, and prevents the wearer from being ejected from the vehicle. It also has an air hose with a quick release valve and a one-way valve to enables the vest to be disconnected quickly, while remaining inflated until the wearer arrives at a medical facility. While the invention has been described in detail, it will be better understood by those skilled in the art, that changes may be made in the air vests material and equivalents may be substituted without departing from the true spirit and scope of the invention.

### BRIEF DESCRIPTION OF THE DRAWINGS

FIG. 1. shows the front view of the overall invention.

FIG. 2 shows the rear view of the overall invention.

FIG. 3. shows a side view of the invention in use in an automobile (buckles are not clearly shown for clarity).

### DETAILED DESCRIPTION OF THE ILLUSTRATIVE EMBODIMENT

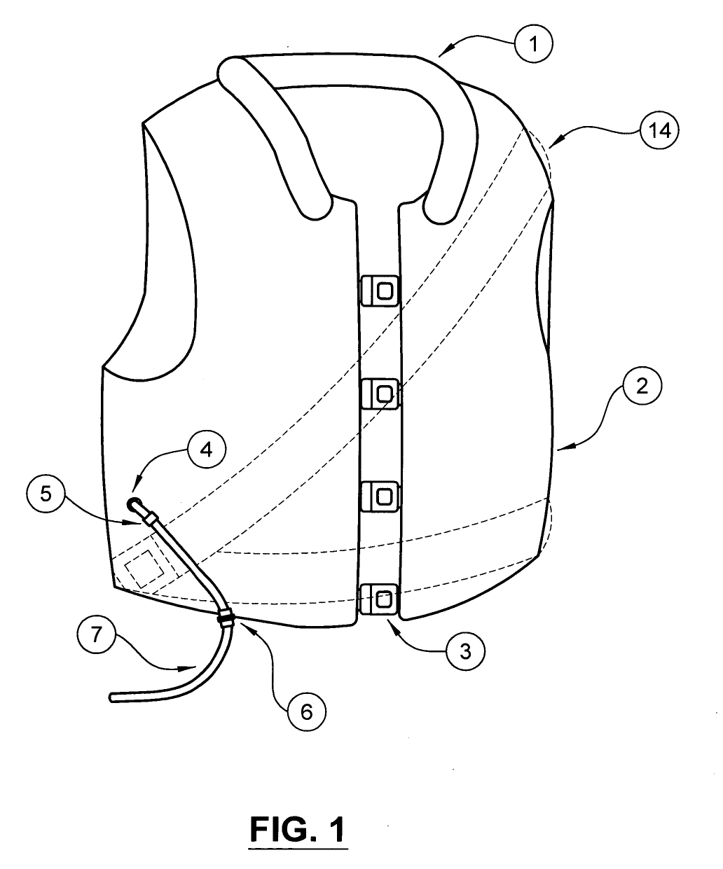

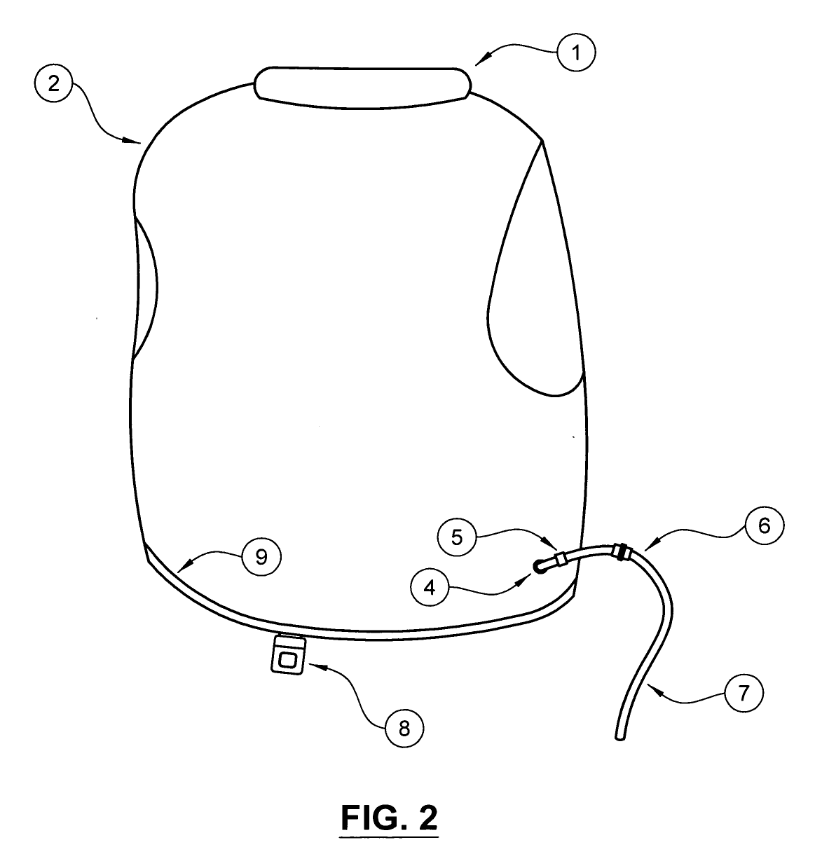

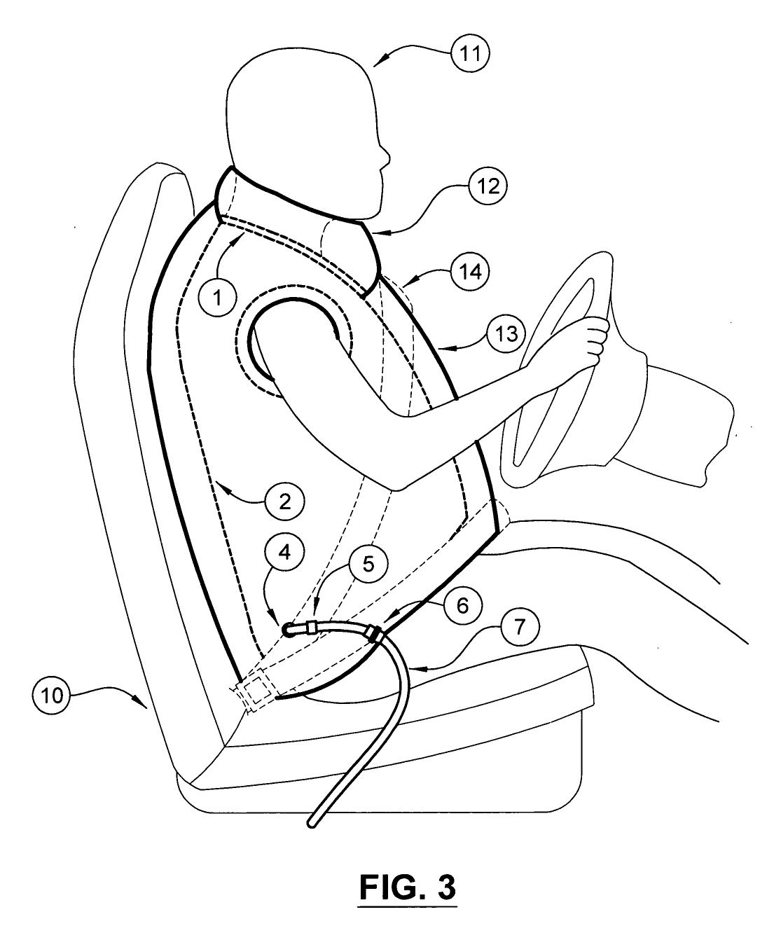

The preferred embodiment of the safety vest 2 is shown in FIGS. 1 and 2. The safety vest is shown worn in an automobile in FIG. 3. The safety vest 2 is comprised of an inflatable tubing vest 2 that includes an inflatable collar 1, a set of buckles 3, an inflation tube 4 that connects 7 to the automobile's air bag inflation system a quick disconnect 6, a one-way valve 5 that prevents the vest 2 from deflating after activation, a buckle 8 that attaches to the automobile seat 10, and a metal bar 9 that attaches the buckle 8 to the safety vest.

The occupant wears the inflatable vest 2 similar to a standard clothing vest. After putting the vest 2 on, the buckles device 3 are fastened. Upon entering the car, the wearer fastens the rear vest buckle 8 to the seat 10. The rear buckle prevents ejection from the vehicle by being securely fastened to the vest using a metal bar 9 located in the lower rear part of the vest 2. After securing the rear buckle, the occupant fastens the primary restraint system (seatbelt) 14. The wearer then attaches the vest to the automobile's airbag system quick release valve 6.

When the airbag system of the automobile activates during an accident, the expanding gasses are routed to the safety vest 2 through the airbag connection 7 through the inflation tube 4. These gases are held inside the vest by the one-way valve 5. The vest 2 inflates 13 and isolates the head and spinal column. Direct contact with the neck and head area 11 by the inflated collar 12 prevents movement and additional injury.

I claim:

1. A Safety Air Vest Equipment (S.A.V.E.) device.
Comprising of a shell that can be made of hollow mesh tubes or a solid fabric with a neck opening and a pair of opposed arm holes, with an air hose that connects to the vest and runs under the floor mat in the vehicle, up through the steering column where it connects to the air bag in the steering wheel. This device can be used to supplement a vehicles standard safety equipment.
The Safety Air Vest Equipment (S.A.V.E.) device works in conjunction with the vehicles standard seatbelt and air bag system. Upon deployment of the vehicle airbag system, air is pushed immediately through the safety air vest hose causing the air vest and neck collar to inflate and stabilize the wearer's neck and torso area.: Thus assisting to decrease the chance of cervical or spinal cord injury.
The safety air vest equipment as described in claim 1, also contains a quick release rear seat buckle device, that pivots back and forward. This prevents the wearer from being ejected from the vehicle in an accident. It also assists in the stabilization of the wearer.
The safety air vest equipment as describe in claim 3, also contains a one-way valve, that is attached in the vests air line, which enables the vest to remain inflated, so medical personnel can remove the wearer from vehicle, maintaining a stabilized cervical and spinal cord.
The safety air vest device as described in claim 1. Also contains a quick release valve, that is located below the one-way valve which enables the wearer to be removed from the vehicle quickly.
